(19) United States
(12) Patent Application Publication
(10) Pub. No.: US 2006/0161938 A1
(43) Pub. Date: Jul. 20, 2006

(54) Optical disk player

(75) Inventors: Won Youl Bae, Suwon-Si (KR); Tae Myun Kim, Yongin-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/201,205

(22) Filed: Aug. 11, 2005

(30) Foreign Application Priority Data
Jan. 20, 2005 (KR) 2005-5477

(51) Int. Cl. G11B 7/08; G11B 7/085; G11B 7/09

(52) U.S. Cl. 720/663

(57) ABSTRACT

An optical disk player which has low production costs and prevents the generation of noise. The optical disk player includes a pick-up device for recording data on a disk or reading the data recorded on the disk and a feeding device for moving the pick-up device in a radial direction of the disk. The feeding device includes a feeding motor, a lead screw rotated by the feeding motor, and a slider. The lead screw has a spiral groove formed in the outer cylindrical surface thereof. The slider includes contact portions inserted into the spiral groove of the lead screw to convert the rotary motion of the lead screw into a rectilinear reciprocating motion and a pressure portion for preventing the contact portions from being separated from the spiral groove, thereby preventing the generation of noise.

### CROSS-REFERENCE TO RELATED APPLICATION

This application claims the benefit under 35 U.S.C. § 119(a) of Korean Patent Application No. 2005-5477, filed Jan. 20, 2005, in the Korean Intellectual Property Office, the entire disclosure of which is hereby incorporated by reference.

### BACKGROUND OF THE INVENTION

1. Field of the Invention

The present invention relates to an optical disk player. More particularly, the present invention relates to a power transmission member for transmitting driving force from a feeding motor to an optical pick-up device.

2. Description of the Related Art

Generally, the term “optical disks” (hereinafter, referred to as disks) refers to storage media for recording and reproducing data, such as voice, images, and documents, by changing the reflection of a laser light through a plurality of pits formed on the surface of each of the disks. Examples of such disks include a CD (compact disk) and a DVD (digital versatile disk). An optical disk player is an apparatus for recording data on the optical disks or reproducing data recorded on the optical disks.

A conventional optical disk player generally comprises a spindle motor for rotating a disk, an optical pick-up device for recording data on the rotated disk or reading data from the disk (hereinafter, referred to a “pick-up device”), and a feeding device for performing a feeding motion for transferring the pick-up device in a radial direction of the disk.

Korean Laid-open Patent Publication No. 2004-0018015, which is assigned to the assignee of the present invention, discloses a feeding device for an optical disk player. The feeding device of that publication comprises a lead screw provided with a spiral groove formed therein, a driving motor for rotating the lead screw, and power transmission means for converting the rotating motion of the lead screw into a rectilinear reciprocating motion and transmitting the rectilinear reciprocating motion of the lead screw to a pick-up device. The power transmission means includes a slider having a contact portion inserted into the spiral groove of the lead screw, and an elastic member for elastically urging the slider towards the lead screw so that the slider elastically contacts the spiral groove. This feeding device reciprocates the pick-up device from the innermost circumference of a lead-in region of a disk to the outermost circumference of a lead-out region of the disk.

A stepping motor, which is generally used as a feeding motor of the feeding device, must be initialized when power is turned on or when an optical disk is inserted into the optical disk player, so as to precisely control the position of the pick-up device. Accordingly, to initialize the feeding motor, the pick-up device performs a slide-in motion that moves the pick-up device to the innermost circumference of the disk.

In one method for performing the above slide-in motion, a limit switch for sensing when the pick-up device reaches the innermost circumference of the disk is installed in the optical disk player, and the feeding motor is driven until the limit switch is turned on. In another method for performing the slide-in motion, it is assumed that the pick-up device is initially located at the outermost circumference of the disk, and the feeding motor is rotated at a designated angle by a distance such that the pick-up device reaches the innermost circumference of the disk.

The first method requires a limit switch, and therefore has the disadvantage of increased unit cost due to the cost of the additional part. In the second method, the pick-up device is not always located at the outermost circumference of the disk as assumed, but sometimes is located at an inner portion of the disk. Therefore, the second method has the disadvantage that the feeding motor sometimes continues to rotate even after the pick-up device reaches the innermost circumference of the disk. When the feeding motor is rotated after the pick-up device reaches the innermost circumference of the disk, the contact portion of the slider is separated from the spiral groove of the lead screw so that it is difficult to precisely control the location of the pick-up device, and the repetition of the insertion and separation of the contact portion into and from the spiral groove generates noise.

Accordingly, there is a need for an optical disk player with an improved feeding device which is inexpensively manufactured and generates reduced noise levels.

### SUMMARY OF THE INVENTION

An aspect of the present invention is to solve at least the above problems and/or disadvantages and to provide at least the advantages described below. Accordingly, an aspect of the present invention is to provide an optical disk player which has a simple configuration, thus being easily manufactured and having low production costs.

Another aspect of the invention is to provide an optical disk player which prevents contact portions of a slider from being separated from a spiral groove of a lead screw, thus reducing generation of noise.

In accordance with one aspect of the present invention, an optical disk player comprises a pick-up device for recording data on a disk or reading the data recorded on the disk, and a feeding device. The feeding device includes a feeding motor, a lead screw rotated by the feeding motor and provided with a spiral groove formed in the outer cylindrical surface thereof, and a slider for converting the rotating motion of the lead screw into a rectilinear reciprocating motion and transmitting the rectilinear reciprocating motion to the pick-up device, and moving the pick-up device in a radial direction of the disk. The slider includes contact portions inserted into the spiral groove of the lead screw and a pressure portion for causing the contact portions to firmly contact the spiral groove so that the contact portions are not separated from the spiral groove. Preferably, the pressure portion is located at one side of the lead screw opposite to the side of the lead screw where the contact portions are located. The pressure portion may have a hook shape which is latched onto the lead screw so that the pressure portion pulls the contact portions.

Further, preferably, the slider may include a first body connected to the pick-up device, a second body located close to the lead screw, and a connection portion connecting the first body and the second body, wherein the connection portion is elastically deformed. Moreover, preferably, a spring for pressing the second body to the lead screw may be installed between the first body and the second body, and covers for preventing the separation of the spring may be provided on the slider.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a plan view of an optical disk player in accordance with an embodiment of the present invention;

FIG. 2 is an enlarged view of the portion “A” of FIG. 1;

FIG. 3 is a perspective view illustrating a portion of the optical disk player of FIG. 1; and

FIG. 4 is a sectional view of a portion of the optical disk player of FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

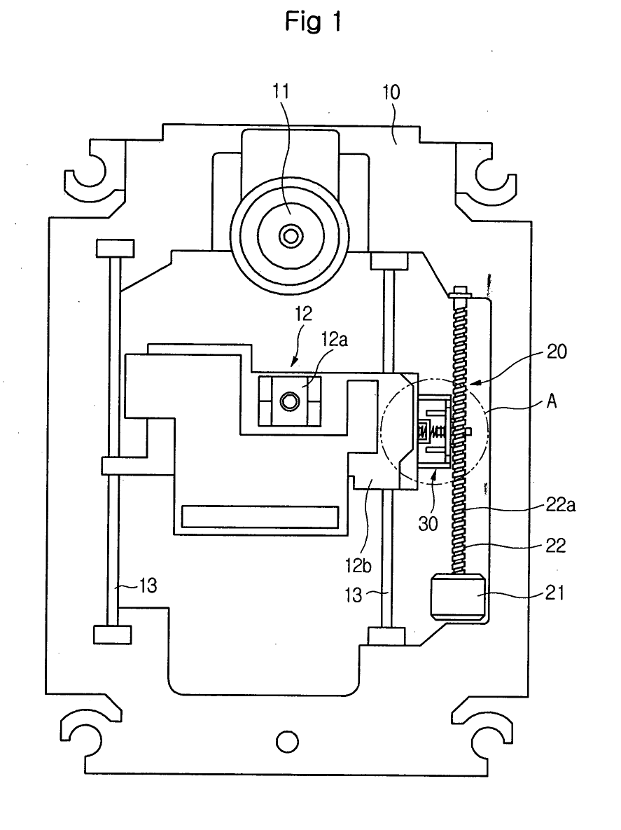

With reference to FIG. 1, an optical disk player in accordance with an embodiment of the present invention has a base chassis 10 made of a metal plate. Various components are installed on the base chassis 10. A spindle motor 11 for rotating a disk is installed at one side of the base chassis 10. A pick-up device 12 moving in the radial direction of the disk for recording data on the disk or reading the data recorded on the disk is installed at the side of the spindle motor 11. The pick-up device 12 includes an optical system 12a having a plurality of lenses and a laser diode optical detector, and a pick-up base 12b on which the optical system 12a is installed. Guide shafts 13 for guiding the movement of the pick-up device 12 are respectively installed at both sides of the pick-up device 12. The two guide shafts 13 are disposed in parallel, and both ends of the guide shafts 13 are firmly fixed to the base chassis 10. The pick-up base 12b is slidably installed on the guide shafts 13.

A feeding device 20 for reciprocating the pick-up device 12 in the radial direction of the disk is installed at the side of the pick-up device 12. The feeding device 20 includes a feeding motor 21, a lead screw 22 rotated by the feeding motor 21, and a slider 30 for converting the rotating motion of the lead screw 22 into a rectilinear reciprocating motion and transmitting the rectilinear reciprocating motion of the lead screw 22 to the pick-up device 12. The feeding motor 21 is fixed to the base chassis 10. The lead screw 22 is installed in parallel with the guide shafts 13, and a spiral groove 22a is formed in the outer cylindrical surface of the lead screw 22.

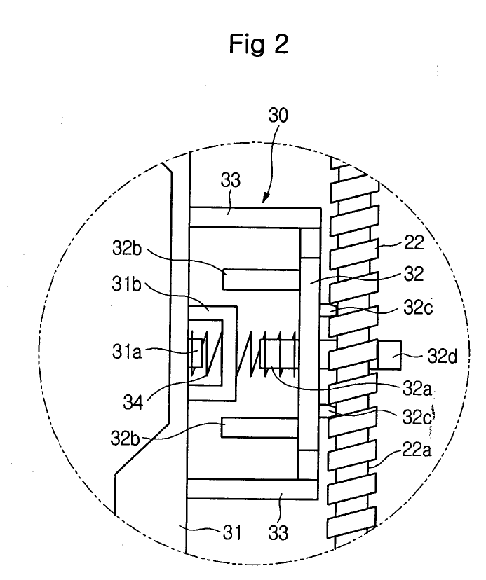

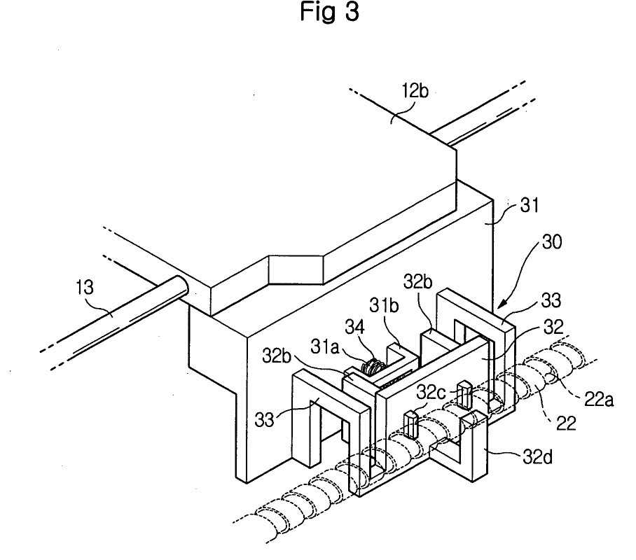

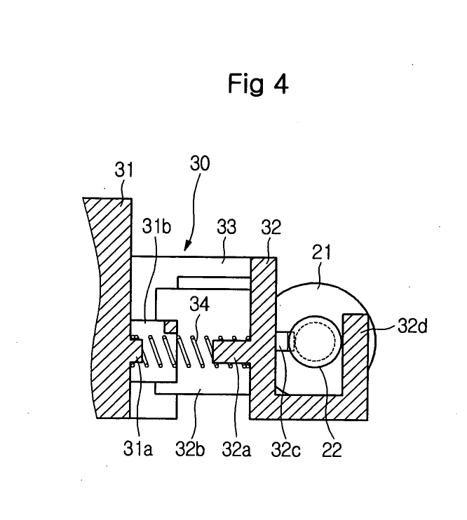

Hereinafter, with reference to FIGS. 2 to 4, the structure of the slider 30 will be described in detail. The slider 30 is preferably made of plastic, such as polyacetal, and includes a first body 31 fixed to the lower surface of the pick-up base 12b, a second body 32 separated from the first body 31 and located close to the lead screw 22, and a connection portion 33 connecting the first body 31 and the second body 32. The connection portion 33 is relatively thin so that it can be elastically deformed by a designated amount. Accordingly, the second body 32 is flexibly connected to the first body 31 by the connection portion 33. A compression spring 34 for applying elastic force to cause the second body 32 to firmly contact the lead screw 22 is installed between the first body 31 and the second body 32. The first body 31 includes a first fixing protrusion 31a inserted into one end of the compression spring 34, and a first cover 31b covering the end of the compression spring 34. The second body 32 includes a second fixing protrusion 32a inserted into the other end of the compression spring 34, and a second cover 32b surrounding the other end of the compression spring 34. The first cover 31b and the second cover 32b prevent the compression spring 34 from being separated from the first fixing protrusion 31a and the second fixing protrusion 32a and coming out.

The second body 32 further includes two contact portions 32c inserted into the spiral groove 22a of the lead screw 22, and a pressure portion 32d for causing the contact portions 32c to firmly contact the lead screw 22 so that the contact portions 32c are not separated from the spiral groove 22a. Although the number of the contact portions 32c illustrated in the exemplary embodiment of the present invention is two, the second body 32 may include any suitable number of contact portions, such as one or more contact portions. Preferably, the second body 32 includes two contact portions to achieve stable contact with the lead screw 22. Further, preferably, the contact portions 32c are inclined at a lead angle of the spiral groove 22a. The pressure portion 32d has a hook shape such that the pressure portion 32d is latched on the lead screw 22 from the lower portion thereof to the upper portion thereof. The pressure portion 32d forcibly pulls the second body 32 when the second body 32 is pushed outwardly from the lead screw 22 to apply force for separating the contact portions 32c from the spiral groove 22a, thereby preventing the contact portions 32c from being separated from the spiral groove 22a.

The optical disk player in accordance with this embodiment does not include a limit switch. Accordingly, the optical disk player employs the second method described above for performing a slide-in motion. That is, when the feeding motor 21 is initialized, it is assumed that the pick-up device 12 is initially located at the outermost circumference of the disk, and the feeding motor is 21 rotated by a distance such that the pick-up device 12 reaches the innermost circumference of the disk. When, in an initial state, the pick-up device 12 is not located at the outermost circumference of the disk but is located at an inner portion of the outermost circumference of the disk, the feeding motor 21 continues to rotate after the pick-up device 12 reaches the innermost circumference of the disk, thereby excessively rotating the lead screw 22. In the optical disk player in accordance with this embodiment, since the pressure portion 32d of the slider 30 causes the contact portions 32c to firmly contact the lead screw 22, the contact portions 32c forcibly fix the lead screw 22, thereby preventing the lead screw 22 from being excessively rotated. Accordingly, it is possible to prevent the contact portions 32c from being separated from the spiral groove 22a of the lead screw 22, thereby preventing the generation of noise.

As is apparent from the above description, the present invention provides an optical disk player which does not have an additional lead screw sensor for sensing when a pick-up device reaches the innermost circumference of a disk when the pick-up device performs a slide-in motion, thereby reducing the cost of components.

Further, a pressure portion formed on a slider causes contact portions to firmly contact a spiral groove of a lead screw. Consequently, the pressure portion forcibly fixes the lead screw when a motor is excessively rotated after the pick-up device reaches the innermost circumference of the disk, thereby preventing the contact portions from being separated from the spiral groove or preventing the generation of noise.

While the invention has been shown and described with reference to certain embodiments thereof, it will be understood by those skilled in the art that various changes in form and details may be made therein without departing from the spirit and scope of the invention as defined by the appended claims.

What is claimed is:

1. An optical disk player comprising:
a pick-up device for recording data on a disk or reading the data recorded on the disk;
a feeding motor;
a lead screw rotated by the feeding motor and provided with a spiral groove formed in the outer cylindrical surface thereof; and
a slider for converting rotary motion of the lead screw into a rectilinear reciprocating motion to move the pick-up device in a radial direction of the disk, the slider including at least one contact portion inserted into the spiral groove of the lead screw and a pressure portion for causing the at least one contact portion to firmly contact the spiral groove so that the at least one contact portion is not separated from the spiral groove.

2. The optical disk player as set forth in claim 1, wherein
the pressure portion and the at least one contact portion are located on opposite sides of the lead screw.

3. The optical disk player as set forth in claim 2, wherein
the pressure portion is hook shaped to latch onto the lead screw.

4. The optical disk player as set forth in claim 1, wherein the slider includes:
a first body connected to the pick-up device;
a second body located proximate to the lead screw; and
an elastically deformable connection portion connecting the first body and the second body.

5. The optical disk player as set forth in claim 4, further comprising
a spring located between the first body and the second body.

6. The optical disk player as set forth in claim 5, further comprising
covers located on the slider for preventing the ends of the spring from separating from the slider.

7. A feeding device for moving a pick-up device in an optical disk player in a radial direction of a disk; comprising:
a feeding motor;
a cylindrical lead screw rotated by the feeding motor, the lead screw having a spiral groove formed on the outer surface of the screw;
a slider for converting rotary motion of the lead screw into a rectilinear reciprocating motion and move the pick-up device in a radial direction of the disk, the slider including at least one contact portion which is inserted into the spiral groove of the lead screw and a pressure portion to prevent the contact portion from being separated from the spiral groove.

8. The feeding device as set forth in claim 7, wherein
the pressure portion and the at least one contact portion are located on opposite sides of the lead screw.

9. The feeding device as set forth in claim 8, wherein
the pressure portion is hook shaped to latch onto the lead screw.

10. The feeding device as set forth in claim 7, wherein the slider includes:
a first body connected to the pick-up device;
a second body located proximate to the lead screw; and
an elastically deformable connection portion connecting the first body and the second body.

11. The feeding device as set forth in claim 10, further comprising
a spring located between the first body and the second body.

12. The feeding device as set forth in claim 11, further comprising
covers located on the slider for preventing the ends of the spring from separating from the slider.

13. The feeding device as set forth in claim 7, wherein
the at least one contact portion comprises two contact portions.

14. The feeding device as set forth in claim 13, wherein
the two contact portions are inclined at a lead angle of the spiral groove.
